(19) United States
(12) Patent Application Publication
(10) Pub. No.: US 2010/0313537 A1
(43) Pub. Date: Dec. 16, 2010

(54) DETHATCHER

(76) Inventor: William R. Lundberg, Sebeka, MN (US)

Correspondence Address: IPLM GROUP, P.A., POST OFFICE BOX 18455, MINNEAPOLIS, MN, 55418, US

(21) Appl. No.: 12/815,917

(22) Filed: Jun. 15, 2010

Related U.S. Application Data
(60) Provisional application No. 61/187,419, filed on Jun. 16, 2009.

(51) Int. Cl. A01B 45/00; A01D 43/02

(52) U.S. Cl. 56/14.9; 56/14.7

(57) ABSTRACT

A dethatcher is provided that includes a base, a plurality of tines and a foot manipulator assembly. The plurality of tines extends from the base and is configured to engage a ground surface. The foot manipulator assembly is coupled and arranged to move the base up and down based on pressure provide by at least one foot of an operator.

### CROSS-REFERENCE TO RELATED APPLICATIONS

This Application claims priority to U.S. Provisional Application Ser. No. 61/187,419, same title herewith, filed on Jun. 16, 2009, which is incorporated in its entirety herein by reference.

### BACKGROUND

Over time, a thatch layer of tightly interwoven decaying cut grass, leaves and roots develop on the soil between blades of grass that make up a lawn. When the layer of thatch becomes too thick it prevents the grass from absorbing needed nutrients. To prevent too thick of a buildup of thatch, dethatchers have been developed. A typical dethatcher resembles a rake that is pulled behind a lawn tractor.

For the reasons stated above and for other reasons stated below which will become apparent to those skilled in the art upon reading and understanding the present specification, there is a need in the art for an effective and efficient dethatcher that is mounted to a zero-turn lawn mower.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a dethatcher is provided. The dethatcher includes a base, a plurality of tines and a foot manipulator assembly. The plurality of tines extends from the base and is configured to engage a ground surface. The foot manipulator assembly is coupled and arranged to move the base up and down based on pressure provide by at least one foot of an operator.

### BRIEF DESCRIPTION OF THE DRAWINGS

The present invention can be more easily understood and further advantages and uses thereof more readily apparent, when considered in view of the detailed description and the following figures in which:

FIG. 1 is a first side perspective view a dethatcher of one embodiment of the present invention coupled to a mower;

FIG. 2 is a second side perspective view of the dethatcher of FIG. 1 coupled to the mower; and

FIG. 3 is back view of the dethatcher of FIG. 1 coupled to the mower being activated.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical changes may be made without departing from the spirit and scope of the present invention. The following detailed description is, therefore, not to be taken in a limiting sense, and the scope of the present invention is defined only by the claims and equivalents thereof.

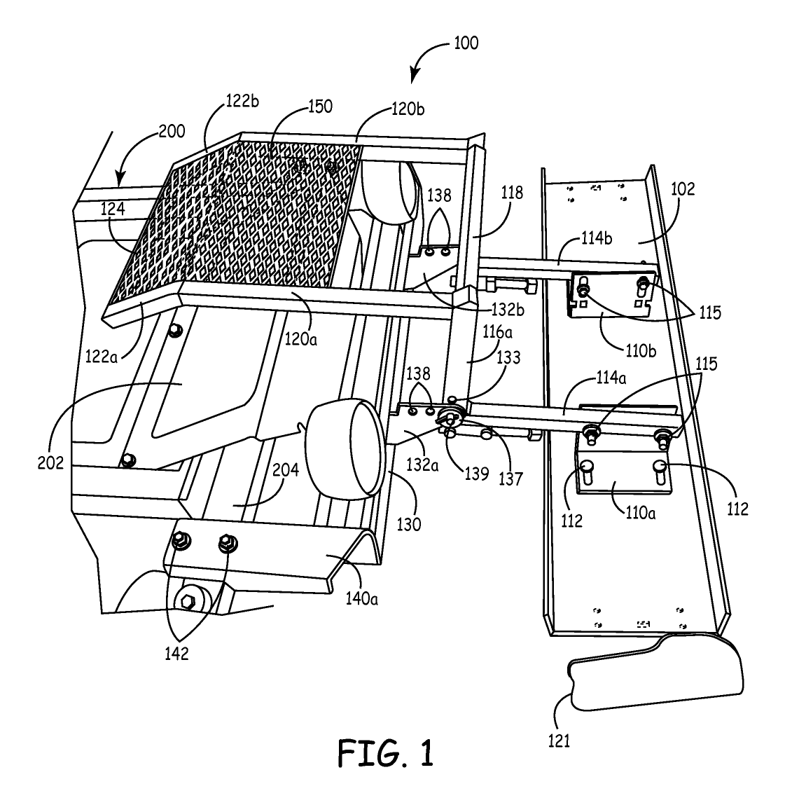

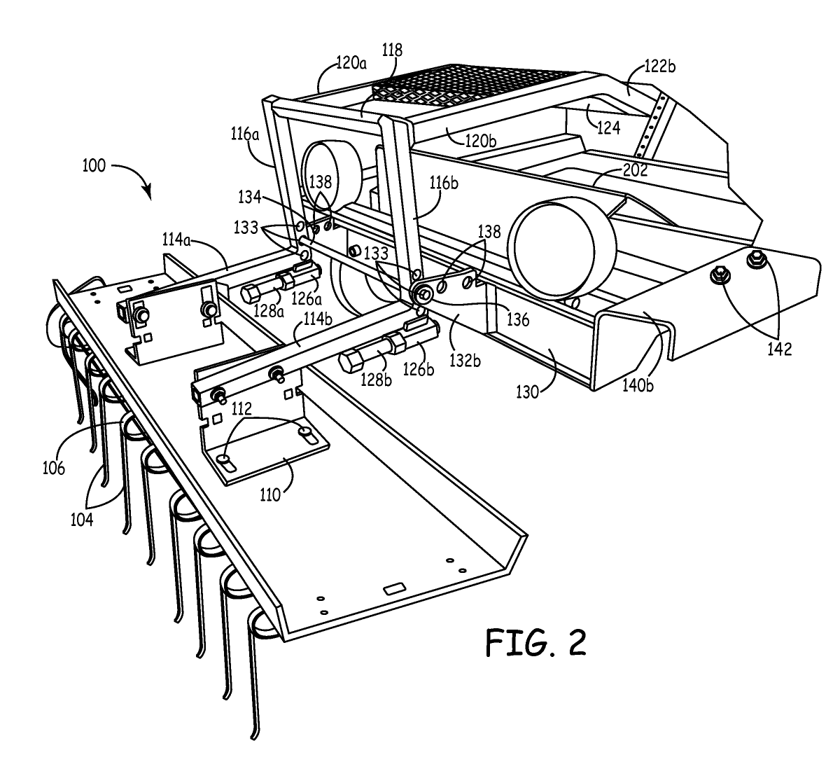

Embodiments of the present invention provide a dethatcher that mounts to a zero-turn lawnmower. Referring to FIGS. 1 and 2, a first and a second side perspective view of dethatcher 100 of one embodiment coupled to a mower 200 is illustrated. The dethatcher 100 in this embodiment includes a base 102 upon which a plurality of tines 104 extend from a first surface of the base 102 to engage the surface of the ground. In one embodiment the tines 104 include a spring portion 106 proximate the base 102. Also attached to the base 102 in one embodiment is a side plate 121 (skid plate). The side plate 121 prevents the tines 104 from digging into the ground beyond a select distance in an embodiment. In one embodiment the side plate 121 is adjustable so the select distance can be changed depending on the application. In another embodiment, the side plates 121 are not used. In yet another embodiment, one or more wheels (not shown) are used in place of the skid plate 121. In further yet another embodiment more than one skid plate 121 is used.

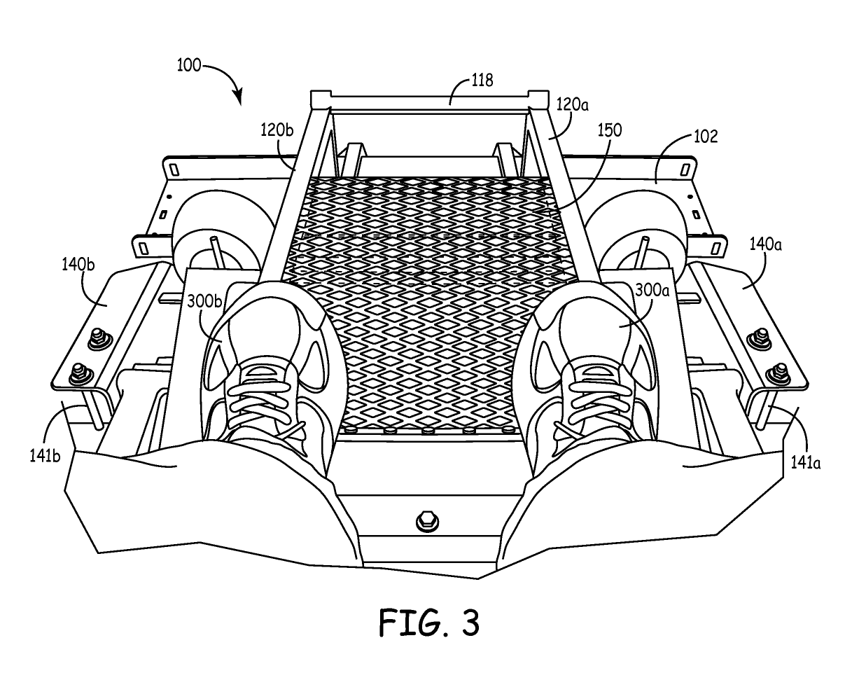

Two base brackets 110a and 110b are coupled to a second surface of the base 102. In one embodiment, the base brackets 110a and 110b are coupled to the base 102 via fasteners 112. A pair of base arm members 114a and 114b are coupled to the respective base brackets 110a and 110b. In particular, a first end of each base arm member 114a and 114b are coupled to a respective base bracket 110a and 110b via fasteners 115. A second end of the base arm members 114a and 114b are coupled to respective spacing members 116a and 116b. In particular, in an embodiment, first ends of spacing members 116a and 116b are coupled to extend generally at a perpendicular angle from the respective second ends of the base arm members 114a and 114b. Second ends of spacing members 116a and 116b are coupled to respective activation arm members 120a and 120b. In particular in one embodiment, first ends of the respective activation arm members 120a and 120b extend generally perpendicular from second ends of the spacing members 116a and 116b. Moreover, the activation aim members 120a and 120b extend from the respective spacing member 116a and 116b in generally an opposite direction than the respective base aim members 114a and 114b. The pair of base arm members 114a and 114b, the spacing members 116a and 116b and the activation arm members 120a and 120b form a frame. The frame in this embodiment further includes a pair of positioning arm members 122a and 122b that extend respectively from second ends of the activation arm members 120a and 120b at select angles. This arrangement allows the positioning arm members 122a and 122b to be positioned proximate a foot resting deck 202 of the mower 200 for easy activation by the user's feet 300a and 300b as discussed below. A first support member 124 is coupled between second ends of the positioning arm members 122a and 122b. A second support member 118 is coupled between the second ends of the spacing members 116a and 116b. As further illustrated in FIGS. 1 through 3, a mesh grate 150 is positioned over a top portion of the activation anus members 120a and 120b and a top of the positioning arm members 122a and 122b. As illustrated in FIG. 3, the mesh grate 150 provides a surface upon which a user's feet rest and adjust the positioning of the dethatcher 100. The above described form, in part, a foot manipulation assembly.

The dethatcher 100 further includes a mower bracket 130 that is designed to be selectively coupled to the mower 200. The mower bracket 130 is generally U-shaped in one embodiment. Ends of the mower bracket 130 terminates in first and second side members 140a and 140b that are designed to be mounted to an axel 204 of the mower 200 via fasteners 142. In one embodiment, the fasteners 142 are part of a U-bolt connector 141a and 141b that extends around the axel 204 and is secured with threaded nuts. The mower bracket 130 can remain on the mower 200 when the dethatcher 100 is disconnected in this embodiment. Extending from a front face of the mower bracket is a pair of mounting brackets 132a and 132b. Each of the mounting brackets 132a and 132b includes a plurality of brackets attaching apertures 138. In mounting the dethatcher 100 on the mower 200, a select pair of bracket attaching apertures 138 are aligned with a select pair of spacing apertures 133 in the spacing members 116a and 116b. A pivot rod 134 is then passed through the respective pair of bracket attaching apertures 138 and spacing apertures 133 to retain the dethatcher 100 to the mower 200. The pivot rod is selectively retained in the respective pair of bracket attaching apertures 138 and pair of spacing apertures 133 via a head 136 at one end and a cotter pin 139 and washer 137 arrangement at another end. The plurality of the bracket attaching apertures 138 in the mounting brackets 132a and 132b and the plurality of spacing apertures 133 in the spacing members 116a and 116b allow for adjustments in the positioning of the dethatcher 100 in relation to the mower 200. The pivot rod 134 provides a pivot point upon which the dethatcher 100 is pivoted to adjust the position of the tines 104 in relation to the ground. Further illustrated in FIG. 2 is stop assemblies including threaded rods 128a and 128b and threaded housings 126a and 126b that can be used in one embodiment. The threaded housings 126a and 126b are coupled to the respective base arm member 114a and 114b proximate the connection to the spacers 116a and 116b. The threaded rods 128a and 128b can be adjusted (threadably turned) in relation to the threaded housing 126b so that a respective end of each threaded rod 128a and 128b can engage the mower bracket 130 to prevent the dethatcher 100 from digging too far into the ground.

In use, the operator or user manipulates the dethatcher 100 with the use of his or her foot or feet. This is important in a zero-turn mover application since a zero-turn mower 200 is operated with the use of two handles. Hence, the operator must use both of his or her hands to manipulate both handles of the mower 200 to keep the mower moving. Moreover, embodiments allow the operator to dynamically move the tines 104 of the dethatcher 100 up or down as the mower 200 is moving as the situation warrants. For example, as the mower 200 is moving along a stretch of lawn that needs a deep dethatching the operator applies no pressure with his or her foot on the foot manipulator assembly 108 and the tines 104 are allowed to go into the ground as far as the side plate 120 or stop assemblies allow. If a stretch of lawn is then encountered that needs less dethatching the operator applies some pressure to the foot manipulator assembly 108 to move the tines up some. If a stretch is encountered that doesn't need any dethatching (like a side walk, driveway or newly seeded patch) the operator simply applies more pressure to the foot manipulator assembly 108 with his or her foot. Hence, in embodiments, the depth of the tines 104 going into the ground can be dynamically adjusted on the fly by adjusting the pressure supplied by the operator's feet. This system provides the operator a better feel and control of the dethatching process. In particular, it provides feedback to the operator regarding the position of the tines 104 without a visual verification that could distract the operator from operating the mower 200. The feedback comes via the operator feet or foot sensing the distance the foot manipulator assembly 108 is from a foot resting deck 202 of the mower 200. Also, the feedback comes from vibrations in the foot manipulator assembly 108. The vibrations in the foot manipulator 108 will be different depending on how far the tines 104 are digging into the ground and whether the tines are not engaging the ground. Once the operator become familiar with the vibrations sensed by their feet during use, they can use the vibrations as feedback to determine if the dethatcher 100 is in the correct position for the then current situation without a visual check.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. For example, the embodiments are described as applying to a zero-turn radius mower. However, the invention can be applied to any type of vehicle using a dethatcher. Therefore, it is manifestly intended that this invention be limited only by the claims and the equivalents thereof

1. A dethatcher comprising:
a base;
a plurality of tines extending from the base, the tines configured to engage a ground surface; and
a foot manipulator assembly coupled and arranged to move the base up and down based on pressure provide by at least one foot of an operator.

2. The dethatcher of claim 1, wherein the foot manipulator assembly provides feedback to an operator regarding the dethatcher's then current operational position during use.

3. The dethatcher of claim 1, wherein the foot manipulator assembly further comprises:
a frame pivotally coupled to bracket attached to a vehicle.

4. The dethatcher of claim 3, further comprising:
a pivot rod rotationally coupling the frame to the bracket.

5. The dethatcher of claim 3, wherein the frame further comprises:
at least one base arm member having a first end coupled to the base;
at least one spacing member having a first end extending generally perpendicular from a second end of the base arm member; and
at least one activation arm having a first end extending generally perpendicular from a second end of the spacing member, the at least one activation arm further extending from the spacing member in a direction that is opposite the direction the at least one base arm extends from the spacing member.

6. The dethatcher of claim 5, further comprising:
at least one positioning arm coupled at a select angle from an end of the at least one activation arm; and
a mesh grate coupled, at least in part, to the at least one positioning arm.

7. The dethatcher of claim 1, further comprising:
at least one skid plate coupled to the base.

8. The dethatcher of claim 1, further comprising:
at least one stop assembly configured and arranged to restrict the movement of the dethatcher in one direction.

9. A dethatcher comprising:
a base;
a plurality of tines extending from the base configured and arranged to engage a ground surface;
a bracket configured and arranged to be coupled to a vehicle; and
a frame pivotally coupled to the bracket, the frame further coupled to the base, the frame further still having a portion configured and arranged to be engaged by at least one foot of an operator to dynamically position the tines at select distances in relation to the ground surface as the vehicle is moving.

10. The dethatcher of claim 9, further comprising:
a removable pivot rod pivotally coupling the frame to the bracket.

11. The dethatcher of claim 9, wherein the frame further comprises:
a pair of base arm members each having a first end coupled to the base;
a pair of spacing members each having a first end extending generally perpendicular from a second end of a respective base arm member; and
a pair of activation arms each having a first end extending generally perpendicular from a second end of a respective spacing member, each activation arm further extending from a respective spacing member in a direction that is opposite the direction the respective base arm extends from the respective spacing member.

12. The dethatcher of claim 11, wherein the frame further comprising:
a pair of positioning arms, each positioning arm coupled at a select angle from an end of a respective activation arm.

13. The dethatcher of claim 12, wherein the frame further comprises:
a mesh grate coupled to the pair of positioning arms and at least a portion of the activation arms, the mesh grate configured and arranged to be engaged by the at least one foot of the operator.

14. The dethatcher of claim 9, further comprising:
at least one fastener configured and arranged to couple the bracket to an axel of the vehicle.

15. The dethatcher of claim 9, further comprising:
at least one skid plate coupled to the base.

16. The dethatcher of claim 9, further comprising:
at least one stop assembly configured and arranged to restrict the movement of the dethatcher in one direction.

17. A dethatcher comprising:
a base;
a plurality of tines extending from the base configured and arranged to engage a ground surface;
a bracket configured and arranged to be coupled to a vehicle; and
a foot manipulator assembly pivotally coupled the bracket to move the base up and down based on pressure provide by at least one foot of an operator, the foot manipulator assembly further configured and arranged to provide feedback to an operator regarding the dethatcher's then current operational position during use.

18. The dethatcher of claim 17, wherein the feedback is at least one of a position of the foot assembly in relation to a foot resting deck of the vehicle and a vibration made by the dethatcher.

19. The dethatcher of claim 17, wherein the foot manipulator assembly further comprises:
at least one base arm member having a first end coupled to the base; and
at least one activation arm coupled to the at least one base arm member, at least one of the at least one base arm member and the at least one base arm pivotally coupled to the bracket.

20. The dethatcher of claim 19, further comprising:
a mesh grate coupled to at least a portion of the at least one activation arm, the mesh grate configured and arranged to be engaged by the at least one foot of the operator.
